(19) United States
(12) Patent Application Publication
(10) Pub. No.: US 2015/0117295 A1
(43) Pub. Date: Apr. 30, 2015

(54) METHOD AND APPARATUS FOR DEVICE-TO-DEVICE COMMUNICATION

(71) Applicant: Electronics and Telecommunications Research Institute, Daejeon (KR)

(72) Inventors: Choongil YEH, Daejeon (KR); Jae Young AHN, Daejeon (KR)

(21) Appl. No.: 14/525,280

(22) Filed: Oct. 28, 2014

(30) Foreign Application Priority Data
Oct. 30, 2013 (KR) 10-2013-0130493
Jan. 29, 2014 (KR) 10-2014-0011052
Jul. 28, 2014 (KR) 10-2014-0095848

(51) Int. Cl. H04W 76/02; H04W 76/00; H04W 24/08; H04J 1/02; H04J 11/00; H04W 72/00; H04W 56/00

(52) U.S. Cl. CPC H04W 76/023; H04W 72/005; H04W 76/002; H04W 56/001; H04J 1/02; H04J 11/00; H04W 24/08; H04J 2011/0096; H04W 88/02
USPC 370/312

(57) ABSTRACT

A Device-to-Device (D2D) communication method of a first terminal is provided. The first terminal transmits a Physical D2D Broadcasting Channel (PD2DBCH) through a first area of a first frame. The first terminal transmits a signal for D2D synchronization through a second area of the first frame.

### CROSS-REFERENCE TO RELATED APPLICATION

This application claims priority to and the benefit of Korean Patent Application Nos. 10-2013-0130493, 10-2014-0011052, and 10-2014-0095848 filed in the Korean Intellectual Property Office on Oct. 30, 2013, Jan. 29, 2014, and Jul. 28, 2014, the entire contents of which are incorporated herein by reference.

### BACKGROUND OF THE INVENTION

(a) Field of the Invention

The present invention relates to a method and apparatus for D2D communication, which is direct communication between terminals.

(b) Description of the Related Art

Device-to-device (D2D) communication, which is direct communication between terminals, is direct communication between terminals without going through a base station. That is, a terminal may transmit/receive data by directly communicating with other terminals without going through a base station.

Such D2D communication can improve system capacity and transmission speed through a short range gain, a hop gain, and a frequency reuse gain, and reduce transmission delay and power consumption.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for D2D communication having advantages of using a D2D synchronization signal.

An exemplary embodiment of the present invention provides a Device-to-Device (D2D) communication method of a first terminal. The communication method includes: transmitting a Physical D2D Broadcasting Channel (PD2DBCH) through a first area of a first frame; and transmitting a signal for D2D synchronization through a second area of the first frame.

The transmitting of a signal for D2D synchronization may include transmitting a first synchronization signal of signals for the D2D synchronization for at least one of automatic gain control, automatic frequency control, and frame timing acquisition.

The communication method may further include transmitting a Physical D2D Synchronization Channel (PD2DSCH) for the D2D synchronization through the second area.

The transmitting of a PD2DBCH may include transmitting a first physical signal for automatic gain control and at least one PD2DBCH through each subframe of the first area.

The transmitting of a first physical signal may include generating the first physical signal using a second Orthogonal Frequency Division Multiplexing (OFDM) symbol having a smaller length than that of a first OFDM symbol used in a Long Term Evolution (LTE) system.

The generating of the first physical signal may include: generating a first sequence by inserting zeros into a Zadoff-Chu (ZC) sequence; generating the second OFDM symbol having a length that is 1/N (N is a natural number of 2 or more) times a length of the first OFDM symbol using the first sequence; and generating the first physical signal using a continuous plurality of second OFDM symbols.

The transmitting of a first physical signal may further include transmitting the first physical signal using a frequency that is allocated to the PD2DBCH.

The first physical signal may have different values according to a location of a frequency resource that is allocated to the PD2DBCH.

The transmitting of a first physical signal may further include transmitting the first physical signal using a predesignated frequency regardless of a frequency that is allocated to the PD2DBCH.

The transmitting of a first synchronization signal may include generating the first synchronization signal using a second OFDM symbol with a smaller length than that of a first OFDM symbol used in an LTE system.

The generating of the first synchronization signal may include: generating a first sequence by inserting zeros of (N−1) (N is a natural number of 2 or more) times a length of a ZC sequence into the ZC sequence; generating the second OFDM symbol having a length that is 1/N times a length of the first OFDM symbol using the first sequence; and generating the first synchronization signal using a continuous plurality of second OFDM symbols.

The transmitting of a first synchronization signal may include: receiving the first synchronization signal from a second terminal; acquiring synchronization using the first synchronization signal; and transmitting the first synchronization signal to a third terminal.

The transmitting of a PD2DBCH may include transmitting the PD2DBCH that is multiplexed with a Frequency Division Multiplexing (FDM) method in the first area.

Another embodiment of the present invention provides a Device-to-Device (D2D) communication method of a first terminal. The communication method includes: receiving a first synchronization signal for D2D synchronization from a second terminal through a first area of a first frame; and performing at least one of automatic gain control, automatic frequency control, and frame timing acquisition in a time domain using the first synchronization signal.

The first frame includes the first area and a second area for a Physical D2D Broadcasting Channel (PD2DBCH).

The performing may include performing the automatic gain control, the automatic frequency control, and the frame timing acquisition in a time domain using the first synchronization signal before Fast Fourier Transform (FFT) is performed.

The performing may include performing the frame timing acquisition in a time domain through a matched filter using the first synchronization signal.

The communication method may further include: transmitting a second synchronization signal for D2D synchronization to the second terminal through the first area to make the second terminal measure propagation delay using the second synchronization signal; receiving a propagation delay measuring result from the second terminal; and performing timing adjustment for correction of propagation delay using the propagation delay measuring result.

The transmitting of the second synchronization signal may include generating the second synchronization signal that the first terminal and the second terminal can commonly use.

The generating of the second synchronization signal may include: generating a first sequence using a root sequence of ZC sequences; generating a Cyclic Prefix (CP), which is ½ of a length of the first sequence; and generating a Guard Time (GT), which is ½ of a length of the first sequence.

Yet another embodiment of the present invention provides a terminal. The terminal includes a memory, and a processor that is connected to the memory and that performs D2D communication.

The processor generates a first synchronization signal for D2D synchronization using a second OFDM symbol with a smaller length than that of a first OFDM symbol used in a Long Term Evolution (LTE) system and transmits the first synchronization signal through a first area of a first frame.

### BRIEF DESCRIPTION OF THE DRAWINGS

FIG. 1 is a diagram illustrating a structure of a frame for D2D communication according to an exemplary embodiment of the present invention.

FIG. 2 is a diagram illustrating relaying of D2D synchronization according to an exemplary embodiment of the present invention.

FIG. 3 is a diagram illustrating relaying of D2D synchronization according to another exemplary embodiment of the present invention.

FIG. 4 is a flowchart illustrating a TA procedure according to an exemplary embodiment of the present invention.

FIG. 5 is a diagram illustrating a waveform of a D2DSS according to an exemplary embodiment of the present invention.

FIG. 6 is a diagram illustrating a procedure in which a terminal transmits a PD2DSS according to an exemplary embodiment of the present invention.

FIG. 7 is a diagram illustrating a waveform of a PD2DSS according to an exemplary embodiment of the present invention.

FIG. 8 is a diagram illustrating relaying of D2D synchronization according to another exemplary embodiment of the present invention.

FIG. 9 is a diagram illustrating a procedure in which a terminal transmits an SD2DSS according to an exemplary embodiment of the present invention.

FIG. 10 is a diagram illustrating subcarrier mapping of an SD2DSS according to an exemplary embodiment of the present invention.

FIG. 11 is a diagram illustrating a waveform of an SD2DSS according to an exemplary embodiment of the present invention.

FIG. 12 is a diagram illustrating a method in which a terminal transmits an AGC signal according to an exemplary embodiment of the present invention.

FIG. 13 is a diagram illustrating a method in which a terminal transmits an AGC signal according to another exemplary embodiment of the present invention.

FIG. 14 is a diagram illustrating a waveform of an AGC signal according to an exemplary embodiment of the present invention.

FIG. 15 is a block diagram illustrating a configuration of a terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a terminal may indicate a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B (nodeB), an evolved node B (eNodeB), an access point (AP), a radio access station (RAS), a base transceiver station (BTS), a mobile multihop relay (MMR)-BS, a relay station (RS) that performs a function of the BS, and an HR-RS that performs a function of the BS, and may include an entire function or a partial function of the BS, the ABS, the HR-BS, the nodeB, the eNodeB, the AP, the RAS, the BTS, the MMR-BS, the RS, and the HR-RS.

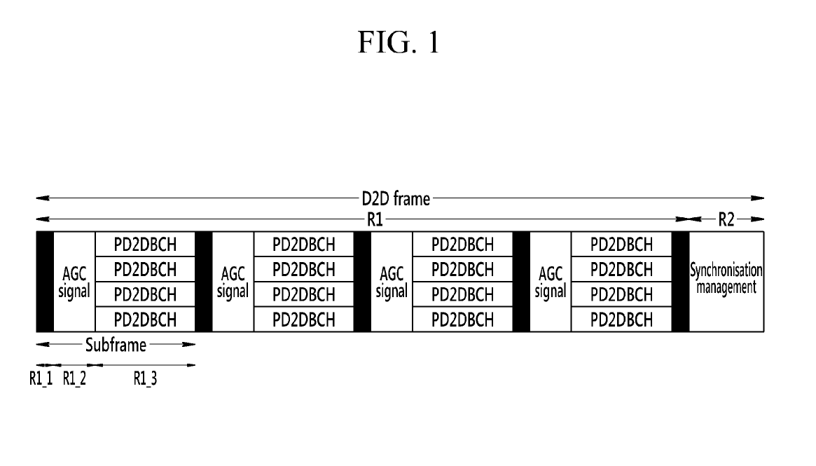

FIG. 1 is a diagram illustrating a structure of a frame for D2D communication according to an exemplary embodiment of the present invention.

Synchronization may be classified into two kings, that is, system level synchronization and link level synchronization. When system level synchronization is set, start and end time points of a frame that all terminals within a specific region recognize are the same. Further, all terminals transmit/receive a signal based on a start time point of a frame. When link level synchronization is set, all terminals are in a state in which a start time point and an end time point of a frame are not set. Therefore, the terminal may transmit a signal regardless of frame timing. Link level synchronization may mean reception timing for demodulation.

When system level synchronization is set, the terminal may acquire a throughput gain, a coverage gain, and a power consumption gain. Specifically, when system level synchronization exists, throughput may be improved to about double. By adapting Single-Carrier Frequency Division Multiple Access (SC-FDMA)/Orthogonal Frequency Division Multiple Access (OFDMA), transmission power may be concentrated and thus coverage can be extended. Because it is necessary for the terminal to only monitor a predetermined segment, power consumption can be reduced.

A frame (hereinafter, ‘D2D frame’) for D2D communication may include a data area R1 and a synchronization management area R2.

At least one Physical D2D Broadcasting Channel (PD2DBCH) may be transmitted through the data area R1. D2D communication is performed through the PD2DBCH.

FIG. 1 illustrates a case in which 4 PD2DBCHs are multiplexed and transmitted with a Frequency Division Multiplexing (FDM) method. Here, the number (e.g., 4) of PD2DBCHs that are multiplexed with an FDM method may be changed according to a frequency width that is allocated to D2D communication.

Specifically, a D2D frame may include a plurality of subframes. The subframe may include an area R1_{—}3 in which 4 PD2DBCHs that are multiplexed with an FDM method are transmitted/received, an area R1_{—}2 in which a physical signal (hereinafter, ‘AGC signal’) for Automatic Gain Control (AGC) is transmitted/received, and an area R1_{—}1 for switching. In the area R1_{—}1, a signal is not transmitted/received. The area R1_{—}2 and the area R1_{—}1 exist at the front or the rear of the area R1_{—}3. Because a set of terminals that transmit a PD2DBCH through each subframe is changed in a subframe unit, an AGC signal is necessary at each subframe.

A Primary D2D Synchronization Signal (PD2DSS), a Secondary D2D Synchronization Signal (SD2DSS), and a Physical D2D Synchronization Channel (PD2DSCH) may be transmitted through the synchronization management area R2. Synchronization related information may be transmitted through the PD2DSCH. In the synchronization management area R2, the PD2DSS, SD2DSS, and PD2DSCH may be multiplexed.

The PD2DSS may be used for signal detection and AGC. A receiving terminal determines whether a present resource is available through signal detection. In order to minimize quantization noise, it is necessary for the terminal to adjust an input signal level of an Analog-to-Digital Converter (ADC). For this reason, the receiving terminal performs AGC. Because a terminal of an LTE system performs AGC by tracking a downlink signal that a base station transmits, a settling time of the AGC is slow. However, in a D2D communication system in which AGC should be performed in a subframe unit, very fast AGC one-shot operation is necessary. Before Fast Fourier Transform (FFT) of a receiving terminal is performed, the AGC should be performed in a time domain. The terminal may perform the above-described form of signal detection and AGC using a repeated short Orthogonal Frequency Division Multiplexing (OFDM) symbol.

The PD2DSS may be used for Automatic Frequency Control (AFC).

It is known that a Signal-to-Noise Ratio (SNR) loss according to a frequency error is proportional to the square of a ratio of a frequency error to a subcarrier gap (i.e., a frequency error/subcarrier gap), as in Equation 1.

SNRₗₒₛₛ∝(fₑᵣᵣ)² (Equation 1)

A subcarrier gap of an LTE compared to a Wireless Local Area Network (WLAN) is very small. For example, a subcarrier gap in a WLAN system may be 312.5 kHz, and a subcarrier gap in an LTE system may be 15 kHz. Therefore, when a frequency error is the same, a WLAN system has a smaller SNR loss than that of an LTE system. Therefore, in a D2D communication system that obeys an OFDM parameter of an LTE system, a procedure that corrects a frequency error through AFC is necessary. Specifically, the terminal may perform AFC in a time domain using a repeated short OFDM symbol. In this case, a limit exists in a frequency error that can be estimated, and a maximum frequency error that can be estimated is represented by Equation 2.

$${f}_{err , max} = \frac{1}{2 D {T}_{s}} \qquad ( Equation 2 )$$

In Equation 2, D is a length of an OFDM symbol, and T_{S} is a sampling gap.

When it is assumed that a 700 MHz carrier frequency and two OFDM symbols having a smaller length by ¼ than an OFDM symbol (hereinafter, ‘LTE OFDM symbol’) used in an LTE system are used, a maximum frequency error that can be estimated is 30 kHz, as in Equation 3. A length of normal Cyclic Prefix (CP) used in an LTE system is 4.96 μs, a length of Extended CP is 16.66 μs, a length of Multicast Broadcast Single Frequency Network (MBSFN) CP is 33.3 μs, and a length of an LTE OFDM symbol, except for a CP, is 1/15,000 s.

$${f}_{err , max} = \frac{1}{2 D {T}_{s}} = \frac{1}{2 ( 512 ) ( {10}^{- 2} / 307200 )} = 30 kHz \qquad ( Equation 3 )$$

When it is assumed that a 700 MHz carrier frequency is used, a frequency error of 30 kHz is 42.86 ppm. A frequency error of a transmitting terminal and a frequency error of a receiving terminal may be in opposite directions, and thus in this case, a frequency error of an oscillator that can be allowed before AFC may be determined to be 20 ppm.

When the terminal estimates a frequency error in a time domain using a repeated OFDM symbol in an Additive White Gaussian Noise (AWGN) channel, estimate distribution is represented by Equation 4.

$${σ}_{{f}_{err}}^{2} ∼ \frac{1}{L \cdot SNR} \qquad ( Equation 4 )$$

In Equation 4, L represents the number of samples used for accumulation.

A length and the number of OFDM symbols may be determined based on the discussion.

A PD2DSS may be used for frame timing acquisition.

The terminal may acquire frame synchronization using a time domain matched filter. Specifically, the terminal may acquire frame synchronization by correlating an input signal and a known short OFDM training symbol through a time domain matched filter.

As described above, the terminal may perform AGC, AFC, and frame timing acquisition in a time domain using a repeated short OFDM symbol.

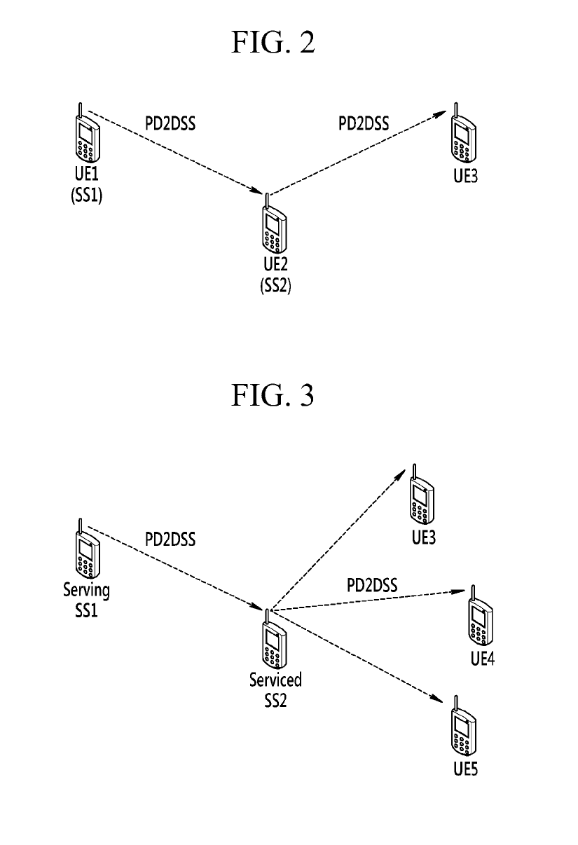

An SD2DSS may be used for Timing Adjustment (TA). TA will be described with reference to FIGS. 2 to 4.

FIG. 2 is a diagram illustrating relaying of D2D synchronization according to an exemplary embodiment of the present invention. Hereinafter, by combining a PD2DSS and an SD2DSS, a D2D Synchronization Signal (D2DSS) is formed. Further, hereinafter, in order to support system level synchronization, a terminal that transmits a D2DSS is referred to as a Synchronization Source (SS).

In D2D communication, a UE1 transmits a PD2DSS to a UE2. The UE1 is SS1. The UE2 acquires time and frequency synchronization using a PD2DSS that the UE1 transmits. The UE2 may again transmit a PD2DSS to a UE3. In this case, the UE2 is SS2.

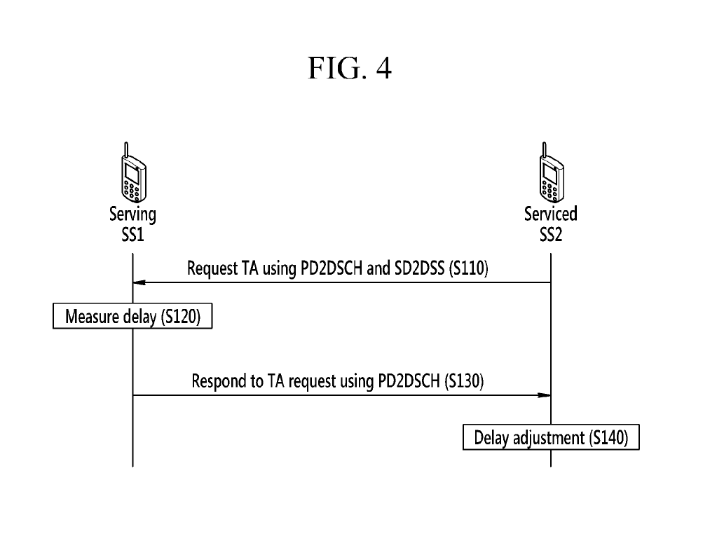

When synchronization is relayed, propagation delay may be accumulated according to an increase of the hop number, and thus a start time point of a frame that UE1-UE3 recognize may exceed an allowance range (error range). A TA procedure is a process of correcting propagation delay. A TA procedure will be described in detail with reference to FIGS. 3 and 4.

FIG. 3 is a diagram illustrating relaying of D2D synchronization according to another exemplary embodiment of the present invention.

The UE1, which is a serving SS1, transmits a PD2DSS to the UE2. The UE2, which is a SS2 that receives a service, acquires synchronization using the received PD2DSS and transmits the PD2DSS to a plurality of UE3-UE5.

FIG. 4 is a flowchart illustrating a TA procedure according to an exemplary embodiment of the present invention.

The UE2, which is SS2 that receives a service (that receives a PD2DSS) in FIG. 3, requests TA from the UE1, which is SS1 that provides a service (that transmits a PD2DSS) (S110). Specifically, the UE2 may request TA through a PD2DSCH. When the UE2 requests TA, the UE2 may transmit an SD2DSS to the UE1.

The UE1 measures propagation delay (or a distance) using the received SD2DSS (S120).

The UE1 notifies the UE2 of the measured propagation delay value (S130). Specifically, the UE1 may respond to a TA request through a PD2DSCH.

The UE2 may adjust propagation delay using the received propagation delay value (S140).

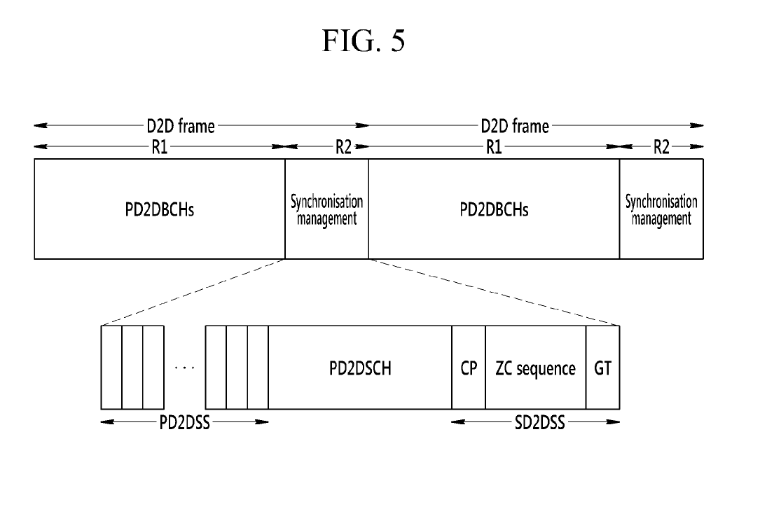

FIG. 5 is a diagram illustrating a waveform of a D2DSS according to an exemplary embodiment of the present invention.

As illustrated in FIG. 5, the terminal may transmit an SD2DSS, a PD2DSCH, and a PD2DSS through a synchronization management area R2. As described above, the PD2DSS is related to AGC, AFC, and frame timing acquisition, and the SD2DSS is related to TA.

Specifically, AGC, AFC, and frame timing acquisition may be processed in a time domain using a repeated short OFDM symbol. In an LTE system, propagation delay is measured using a Zadoff-Chu (ZC) sequence. A receiving node may measure propagation delay using a ZC sequence after FFT.

The terminal may generate repeated smaller OFDM symbols having a length of 1/P of that of a normal OFDM symbol (e.g., LTE OFDM symbol) by mapping a sequence (e.g., M-sequence or ZC sequence having a length of N) at every P-th Resource Element (RE). As illustrated in FIG. 5, the terminal may perform AGC, AFC, and frame timing acquisition in a time domain before FFT is performed using a PD2DSS including repeated short OFDM symbols.

The terminal may perform TA using an SD2DSS including other sequences (e.g., ZC sequence having a length of K). In an LTE system, when the terminal transmits a ZC sequence for TA, the terminal uses a very small subcarrier gap (e.g., 1.25 kHz), a long Cyclic Prefix (CP), and a long Guard Time (GT) (e.g., 0.1, 0.2, 0.68 ms). Coverage of D2D communication system is smaller than that of an LTE system. Further, in an LTE system, an entire terminal requests TA from a base station, which is a single-point receiving node. However, in a D2D communication system, because an SS (e.g., SS2) that performs synchronization relay requests TA from another SS (e.g., SS1) that provides a PD2DSS to the SS, it is unnecessary for the terminal to multiplex and transmit many ZC sequences.

A UE (e.g., UE3 of FIG. 3) that does not perform an SS function may transmit a signal without a TA procedure based on timing of a PD2DSS that the UE receives. Therefore, as illustrated in FIG. 5, in a D2D communication system, an SD2DSS for TA may be connected to a CP of a length of about ½ an OFDM symbol and a GT of a length of about ½ an OFDM symbol in the front-rear direction with a common subcarrier gap (e.g., 15 kHz) and may be used.

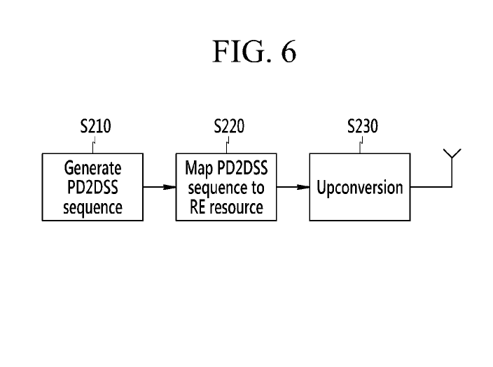

A transmitting procedure of a PD2DSS will be described in detail with reference to FIG. 6.

FIG. 6 is a diagram illustrating a procedure in which a terminal transmits a PD2DSS according to an exemplary embodiment of the present invention. FIG. 6 illustrates, for convenience of description, a case in which a UE (UE1 of FIG. 3) generates a PD2DSS.

The UE1 generates a PD2DSS sequence using various kinds of sequences such as a Maximal-length sequence (M-sequence) and a ZC sequence (S210). FIG. 6 illustrates, for convenience of description, a case in which the UE1 generates a PD2DSS sequence using a ZC sequence. For example, the UE1 may generate a ZC sequence having a length of 62, as in Equation 5.

$${d}_{25} ( n ) = \{ \begin{matrix}{e}^{- jπ ( 25 ) \frac{n ( n + 1 )}{63}} ; n = 0 , 1 , … , 30 \\ {e}^{- jπ ( 25 ) \frac{( n + 1 ) ( n + 2 )}{63}} ; n = 31 , 32 , … , 61\end{matrix} \qquad ( Equation 5 )$$

In order to generate a short OFDM symbol, which is ¼ of a length (e.g., a length of an LTE OFDM symbol) of a normal OFDM symbol, the UE1 generates a PD2DSS sequence d_{PD2DSS}(n) by inserting zeros, as in Equation 6. The UE1 may insert 186(=(4−1)×62) zeros.

d_{PD2DSS}(n)={0,0,0,d₂₅(0),0,0,0,d₂₅(1), . . . ,0,0,0,d₂₅(30),d₂₅(31),0,0,0,d₂₅(32),0,0,0, . . . ,d₂₅(64),0,0,0}; nε{0, . . . ,247} (Equation 6)

When 600REs (RE index k=0, . . . , 599) per OFDM symbol are used, the UE1 maps a PD2DSS sequence d_{PD2DSS}(n) to an RE resource, as in Equation 7 (S220).

aₖ=d_{PD2DSS}(n); n=0, . . . ,247; k=n−124+300 (Equation 7)

The UE1 may generate 5 OFDM symbols of a continuous short length (¼ of a normal length) using aₖ, as in Equation 8.

$${s}_{PD 2 DSS} ( t ) = {\sum }_{k = - 300}^{- 1} {a}_{{k}^{( - )}} \cdot {e}^{j2π k Δ f ( t - 512 \cdot {T}_{s} )} + {\sum }_{k = 1}^{300} {a}_{{k}^{( + )}} \cdot {e}^{j2π k Δ f ( t - 512 \cdot {T}_{s} )} \qquad ( Equation 8 )$$

In Equation 8, k⁽⁻⁾=k+300, and k⁽⁺⁾=k+300−1. In Equation 8, 0≦t<(512+2048)×Tₛ, and a subcarrier gap Δf=15 kHz.

The UE1 upconverts (converts to a high frequency signal) and transmits an OFDM symbol S_{PD2DSS}(t) (S230).

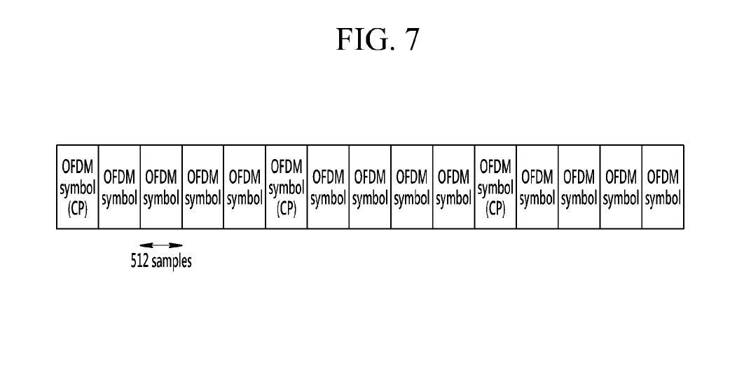

A waveform of a PD2DSS that is transmitted through a process of FIG. 6 will be described in detail with reference to FIG. 7.

FIG. 7 is a diagram illustrating a waveform of a PD2DSS according to an exemplary embodiment of the present invention.

FIG. 7 illustrates a PD2DSS waveform including 15 OFDM symbols of a continuous short length (¼ of a normal length). Specifically, the UE (e.g., UE1 of FIG. 3) may generate 15 OFDM symbols by repeating a process of generating 5 OFDM symbols 3 times, as in Equation 8. A length of one OFDM symbol may correspond to 512 samples.

As illustrated in FIG. 7, a UE (e.g., UE2 of FIG. 3) that receives a PD2DSS having a repeated waveform of a promised form may perform AGC, AFC, and frame timing acquisition using a received PD2DSS.

When the PD2DSS has the above-described form, the remaining REs in which a sequence d_{PD2DSS}(n) is not mapped among 600REs may be transmitted to NULL.

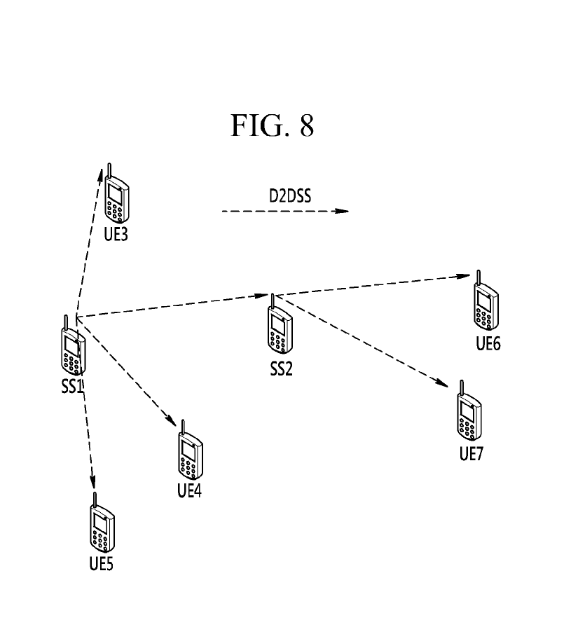

A process in which a terminal acquires D2D synchronization using the above-described PD2DSS and relays D2D synchronization will be described in detail with reference to FIG. 8.

FIG. 8 is a diagram illustrating relaying of D2D synchronization according to another exemplary embodiment of the present invention.

The UE1, which is SS1, transmits a PD2DSS. UE2-UE5 acquire synchronization using a PD2DSS that is received from the UE1. The UE3 may transmit a D2DSS. The UE2, which is SS2, generates a PD2DSS using acquired synchronization and transmits the generated PD2DSS. UE6 and UE7 acquire synchronization using a PD2DSS that is received from the UE2. Thereby, all of UE1-UE7 of FIG. 8 may use the same synchronization. When the UE2 does not relay synchronization, different synchronization may exist within a network.

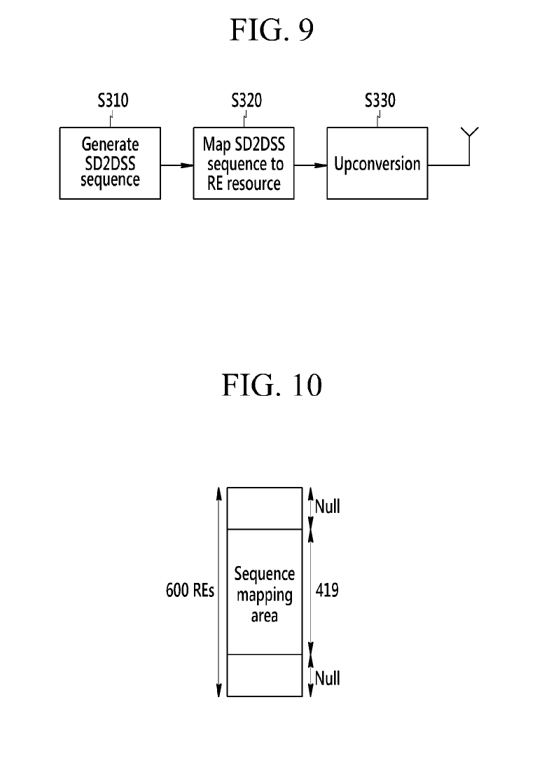

A transmitting procedure of an SD2DSS will be described in detail with reference to FIG. 9.

FIG. 9 is a diagram illustrating a procedure in which a terminal transmits an SD2DSS according to an exemplary embodiment of the present invention. FIG. 9 illustrates, for convenience of description, a case in which the UE (UE2 of FIG. 8) generates an SD2DSS.

In a D2D communication system, when synchronization is relayed with multi-hop, if TA is not defined between SSs (e.g., SS1, SS2), propagation transfer delay is accumulated according to an increase of the number of hops. Therefore, even if TA is not defined between an SS (e.g., SS1, SS2) and a UE (e.g., UE3-UE7), it is necessary to define TA between SSs (e.g., SS1 and SS2). For example, TA is necessary between the UE1 which is SS1 and the UE2 which is SS2 in FIG. 8, but it is unnecessary to define TA between the UE1 which is SS1 and UE3-UE5 by reason of complexity. Because TA does not very frequently occur and the hop number is not high, a waveform of an SD2DSS may be defined in one form, and UEs (e.g., UE1-UE7 of FIG. 8) may commonly use an SD2DSS of one form.

A waveform of an SD2DSS is different from a form of a repeated short OFDM symbol. That is, a PD2DSS has a form of a repeated short OFDM symbol, but an SD2DSS does not have a form of a repeated short OFDM symbol.

The UE2 may generate an SD2DSS sequence using several kinds of sequences (S310). FIG. 9 illustrates, for convenience of description, a case in which the UE2 generates an SD2DSS sequence using a ZC sequence useful for propagation transfer delay measurement. Specifically, a case in which the UE2 generates an SD2DSS using 419 REs among 600 REs is exemplified. The UE2 may use a root sequence, which is u=1 among ZC sequences having a length of 419, as in Equation 9. The UE2 maps an SD2DSS sequence to an RE resource (S320).

$$\begin{matrix}{x}_{1} ( n ) = {e}^{- jπ ( 1 ) \frac{n ( n + 1 )}{419}} ; n ∈ \{ 0 , … , 418 \} . & ( Equation 9 ) \\ {s}_{SD 2 DSS} = {\sum }_{k = 0}^{418} ( {\sum }_{n = 0}^{418} {x}_{1} ( n ) \cdot {e}^{- j \frac{2 π nk}{419}} ) {e}^{j2π ( k + 1 ) Δ f ( t - 1024 )} & \end{matrix}$$

In Equation 9, a range of t is 0≦t≦(1024+2048)·Tₛ.

The UE2 upconverts and transmits an OFDM symbol S_{SD2DSS}(t) (S330).

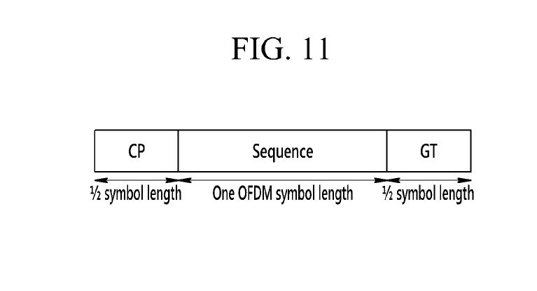

Subcarrier mapping and a waveform of an SD2DSS that is transmitted through a process of FIG. 9 will be described in detail with reference to FIGS. 10 and 11.

FIG. 10 is a diagram illustrating subcarrier mapping of an SD2DSS according to an exemplary embodiment of the present invention.

As illustrated in FIG. 10, a power spectrum of the SD2DSS may be uniformly limited to 419 subcarriers that are located at the center.

FIG. 11 is a diagram illustrating a waveform of an SD2DSS according to an exemplary embodiment of the present invention.

As illustrated in FIG. 11, a waveform of the SD2DSS may include a sequence having a length of one OFDM symbol (e.g., an LTE OFDM symbol). A waveform of the SD2DSS may include a CP having ½ a length of one OFDM symbol (e.g., an LTE OFDM symbol) in front of a sequence. Further, the waveform of the SD2DSS may include a GT having ½ a length of one OFDM symbol (e.g., an LTE OFDM symbol) behind a sequence.

The UE (e.g., UE1 of FIG. 8) may perform distance measurement (delay measurement) between SSs (e.g., SS1 and SS2) using an SD2DSS.

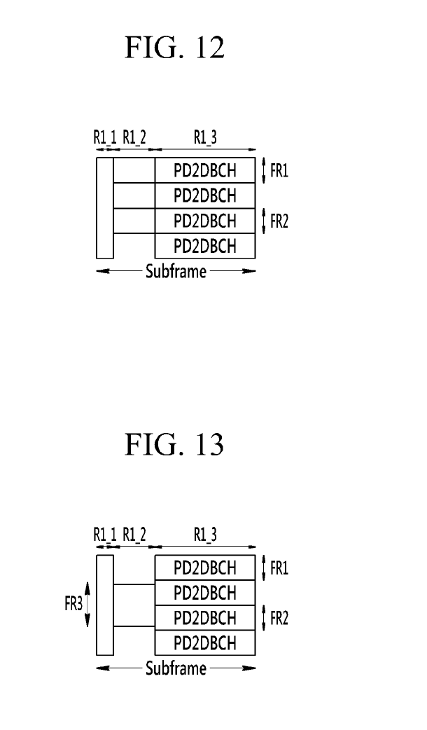

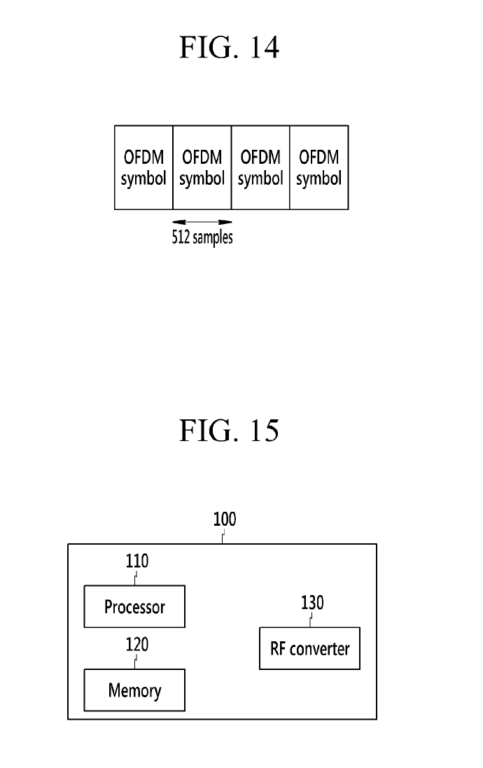

AGC may be performed in a subframe unit. Specifically, a terminal that transmits a PD2DBCH in a specific subframe should transmit an AGC signal. The terminal may transmit an AGC signal with two methods (a first transmitting method and a second transmitting method). Referring to FIGS. 12 and 13, a first transmitting method and a second transmitting method are described in detail, and referring to FIG. 14, a waveform of an AGC signal will be described in detail.

FIG. 12 is a diagram illustrating a method in which a terminal transmits an AGC signal according to an exemplary embodiment of the present invention. FIG. 12 illustrates, for convenience of description, a case in which a UE (UE1 and UE2 of FIG. 8) generates and transmits an AGC signal using a first transmitting method.

The UE1 transmits an AGC signal including a promised sequence in an area R1_{—}2 using a frequency FR1 that a PD2DBCH that is occupied by the UE1 uses. The UE2 transmits an AGC signal including a promised sequence in an area R1_{—}2 using a frequency FR2 that a PD2DBCH that is occupied by the UE2 uses. In this case, a sequence of an AGC signal may be different according to a location of frequency resources FR1 and FR2 that are allocated to a PD2DBCH. For example, a sequence of an AGC signal that is transmitted by the UE1 that occupies a PD2DBCH corresponding to a frequency FR1 may be different from that of an AGC signal that is transmitted by the UE2 that occupies a PD2DBCH corresponding to a frequency FR2.

In order to use an OFDM symbol having a short length (e.g., a smaller length than that of an LTE OFDM symbol) as an AGC signal, the UE1 and UE2 may map a sequence at every Q-th RE.

FIG. 13 is a diagram illustrating a method in which a terminal transmits an AGC signal according to another exemplary embodiment of the present invention. FIG. 13 illustrates, for convenience of description, a case in which a UE (UE1 and UE2 of FIG. 8) generates and transmits an AGC signal using a second transmitting method.

The UE1 transmits an AGC signal including a promised sequence in an area R1_{—}2 using a designated specific frequency FR3 regardless of a frequency resource FR1 that a PD2DBCH that is occupied by the UE1 uses. The UE2 transmits an AGC signal including a promised sequence in an area R1_{—}2 using a designated specific frequency FR3 regardless of a frequency resource FR2 that a PD2DBCH that is occupied by the UE2 uses. FIG. 13 illustrates a case in which a frequency FR3 includes a portion of a frequency FR2. A sequence of an AGC signal that is transmitted by the UE1 and a sequence of an AGC signal that is transmitted by the UE2 may be the same.

In order to use an OFDM symbol having a short length (e.g., a smaller length than that of an LTE OFDM symbol) as an AGC signal, the UE1 and UE2 may map a sequence at every Q-th RE.

FIG. 14 is a diagram illustrating a waveform of an AGC signal according to an exemplary embodiment of the present invention.

A UE (e.g., UE2-UE5 of FIG. 8) performs AGC using a PD2DSS that an SS (e.g., SS1 of FIG. 8) transmits, acquires synchronization, and demodulates a PD2DSCH. In this case, an area (an area in which an AGC signal may be used) in which the AGC using the PD2DSS is effective is limited to a synchronization management area R2 of a D2D frame. In a data area R1 of the D2D frame, an AGC using the PD2DSS is not effective. The PD2DSCH may include SS ID, SS type, power supply type, TA request, TA response, cyclic PD2DSS transmission request information, or cyclic PD2DSCH transmission request information.

As described above, the AGC should be performed at every subframe. FIG. 1 illustrates a case in which 4 PD2DBCHs are multiplexed in a frequency domain at every subframe. Therefore, in each subframe, one PD2DBCH to four PD2DBCHs may be simultaneously transmitted. In this case, terminals may transmit the same sequence using the same REs. When REs used for AGC are different according to each PD2DBCH, a Peak-to-Average Power Ratio (PAPR) of an AGC signal may increase. Because a low PAPR of an AGC signal is good, the terminal may use a ZC sequence. The AGC signal may use a repeated short OFDM symbol, similar to the PD2DSS. In this case, the AGC signal does not use the same sequence as that of the PD2DSS.

For example, the UE (e.g., UE1 of FIG. 8) generates a ZC sequence having a length of 62, as in Equation 10.

$${d}_{29} ( n ) = \{ \begin{matrix}{e}^{- jπ ( 29 ) \frac{n ( n + 1 )}{63}} ; n = 0 , 1 , … , 30 \\ {e}^{- jπ ( 29 ) \frac{( n + 1 ) ( n + 2 )}{63}} ; n = 31 , 32 , … , 61\end{matrix} \qquad ( Equation 10 )$$

In order to generate a short OFDM symbol, which is ¼ of a normal OFDM symbol length (e.g., a length of an LTE OFDM symbol), the UE1 generates a sequence d_{AGC}(n) by inserting zeros, as in Equation 11. The UE1 inserts 186 (=(4−1)×62) zeros.

d_{AGC}(n)={0,0,0,d₂₉(0),0,0,0,d₂₉(1), . . . ,0,0,0,d₂₉(30),d₂₉(31),0,0,0,d₂₉(32),0,0,0, . . . ,d₂₉(61),0,0,0}; nε{0, . . . ,247} (Equation 11)

When it is assumed that 600 REs (RE index k=0, . . . , 599) per OFDM symbol are used, the UE1 maps a sequence d_{AGC}(n) to an RE resource, as in Equation 12.

aₖ=d_{AGC}(n); n=0, . . . ,247; k=n−124+300 (Equation 12)

The UE1 may generate 4 OFDM symbols of a continuous short length (e.g., ¼ of a length of an LTE OFDM symbol) using aₖ of Equation 12, as in Equation 13.

$${s}_{AGC} ( t ) = {\sum }_{k = - 300}^{- 1} {a}_{{k}^{( - )}} \cdot {e}^{j2π k Δ ft} + {\sum }_{k = 1}^{300} {a}_{{k}^{( + )}} \cdot {e}^{j2π k Δ ft} \qquad ( Equation 13 )$$

In Equation 13, k⁽⁻⁾=k+300, and k⁽⁺⁾=k+300−1. In Equation 13, 0≦t<2048×Tₛ, and a subcarrier gap Δf=15 kHz.

FIG. 14 illustrates a waveform of an AGC signal including 4 OFDM symbols S_{AGC}(t) of a continuous short length (e.g., ¼ of a length of an LTE OFDM symbol). As illustrated in FIG. 14, a UE (e.g., UE2 of FIG. 8) that receives an AGC signal having a repeated waveform of a promised form may perform AGC using a received AGC signal.

When an AGC signal has the above-described form, the remaining REs in which a sequence d_{AGC}(n) is not mapped among 600 REs may be transmitted to NULL.

FIG. 15 is a block diagram illustrating a configuration of a UE 100 according to an exemplary embodiment of the present invention.

The UE1-UE7 may have the same configuration as or a configuration similar to that of the UE 100. Specifically, the UE 100 includes a processor 110, a memory 120, and a Radio Frequency (RF) converter 130.

The processor 110 may be formed to implement procedures, functions, and methods that are related to UE1-UE7 that are described in FIGS. 1 to 14.

The memory 120 is connected to the processor 110 and stores various information related to operation of the processor 110.

The RF converter 130 is connected to the processor 110 and transmits/receives a wireless signal. The UE 100 may have a single antenna or multiple antennas.

According to an exemplary embodiment of the present invention, Automatic Gain Control (AGC), Automatic Frequency Control (AFC), and frame timing acquisition can be efficiently performed in a time domain using a D2D synchronization signal including a short Orthogonal Frequency Division Multiplexing (OFDM) symbol.

Further, according to an exemplary embodiment of the present invention, Timing Adjustment (TA) for correcting propagation delay using a D2D synchronization signal can be efficiently performed.

According to an exemplary embodiment of the present invention, a terminal can efficiently acquire D2D synchronization.

In addition, according to an exemplary embodiment of the present invention, a Peak-to-Average Power Ratio (PAPR) of an AGC signal can be minimized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A Device-to-Device (D2D) communication method of a first terminal, the communication method comprising:
transmitting a Physical D2D Broadcasting Channel (PD2DBCH) through a first area of a first frame; and
transmitting a signal for D2D synchronization through a second area of the first frame.

2. The communication method of claim 1, wherein the transmitting of a signal for D2D synchronization comprises transmitting a first synchronization signal of signals for the D2D synchronization for at least one of automatic gain control, automatic frequency control, and frame timing acquisition.

3. The communication method of claim 2, further comprising transmitting a Physical D2D Synchronization Channel (PD2DSCH) for the D2D synchronization through the second area.

4. The communication method of claim 3, wherein the transmitting of a PD2DBCH comprises transmitting a first physical signal for automatic gain control and at least one PD2DBCH through each subframe of the first area.

5. The communication method of claim 4, wherein the transmitting of a first physical signal comprises generating the first physical signal using a second Orthogonal Frequency Division Multiplexing (OFDM) symbol having a smaller length than that of a first OFDM symbol used in a Long Term Evolution (LTE) system.

6. The communication method of claim 5, wherein the generating of the first physical signal comprises:
generating a first sequence by inserting zeros into a Zadoff-Chu (ZC) sequence;
generating the second OFDM symbol having a length that is 1/N (N is a natural number of 2 or more) times a length of the first OFDM symbol using the first sequence; and
generating the first physical signal using a continuous plurality of second OFDM symbols.

7. The communication method of claim 6, wherein the transmitting of a first physical signal further comprises transmitting the first physical signal using a frequency that is allocated to the PD2DBCH,
wherein the first physical signal has different values according to a location of a frequency resource that is allocated to the PD2DBCH.

8. The communication method of claim 6, wherein the transmitting of a first physical signal further comprises transmitting the first physical signal using a predesignated frequency regardless of a frequency that is allocated to the PD2DBCH.

9. The communication method of claim 3, wherein the transmitting of a first synchronization signal comprises generating the first synchronization signal using a second OFDM symbol with a smaller length than that of a first OFDM symbol used in an LTE system.

10. The communication method of claim 9, wherein the generating of the first synchronization signal comprises:
generating a first sequence by inserting zeros of (N−1) (N is a natural number of 2 or more) times a length of a ZC sequence into the ZC sequence;
generating the second OFDM symbol having a length that is 1/N times a length of the first OFDM symbol using the first sequence; and
generating the first synchronization signal using a continuous plurality of second OFDM symbols.

11. The communication method of claim 3, wherein the transmitting of a first synchronization signal comprises:
receiving the first synchronization signal from a second terminal;
acquiring synchronization using the first synchronization signal; and
transmitting the first synchronization signal to a third terminal.

12. The communication method of claim 3, wherein the transmitting of a PD2DBCH comprises transmitting the PD2DBCH that is multiplexed with a Frequency Division Multiplexing (FDM) method in the first area.

13. A Device-to-Device (D2D) communication method of a first terminal, the communication method comprising:
receiving a first synchronization signal for D2D synchronization from a second terminal through a first area of a first frame; and
performing at least one of automatic gain control, automatic frequency control, and frame timing acquisition in a time domain using the first synchronization signal,
wherein the first frame comprises the first area and a second area for a Physical D2D Broadcasting Channel (PD2DBCH).

14. The communication method of claim 13, wherein the first synchronization signal is generated using a second OFDM symbol with a smaller length than that of a first OFDM symbol used in an LTE system.

15. The communication method of claim 14, wherein the performing comprises performing the automatic gain control, the automatic frequency control, and the frame timing acquisition in a time domain using the first synchronization signal before Fast Fourier Transform (FFT) is performed.

16. The communication method of claim 14, wherein the performing comprises performing the frame timing acquisition in a time domain through a matched filter using the first synchronization signal.

17. The communication method of claim 13, further comprising:
transmitting a second synchronization signal for D2D synchronization to the second terminal through the first area to make the second terminal measure propagation delay using the second synchronization signal;
receiving a propagation delay measuring result from the second terminal; and
performing timing adjustment for correction of propagation delay using the propagation delay measuring result.

18. The communication method of claim 17, wherein the transmitting of the second synchronization signal comprises generating the second synchronization signal that the first terminal and the second terminal can commonly use.

19. The communication method of claim 18, wherein the generating of the second synchronization signal comprises:
generating a first sequence using a root sequence of ZC sequences;
generating a Cyclic Prefix (CP), which is ½ of a length of the first sequence; and
generating a Guard Time (GT), which is ½ of a length of the first sequence.

20. A terminal, comprising:
a memory; and
a processor that is connected to the memory and that performs D2D communication,
wherein the processor generates a first synchronization signal for D2D synchronization using a second OFDM symbol with a smaller length than that of a first Orthogonal Frequency Division Multiplexing (OFDM) symbol used in a Long Term Evolution (LTE) system, and transmits the first synchronization signal through a first area of a first frame, and
the first frame comprises the first area and a second area for transmitting/receiving a Physical D2D Broadcasting Channel (PD2DBCH).
